(19) United States
(12) Patent Application Publication
(10) Pub. No.: US 2015/0006732 A1
(43) Pub. Date: Jan. 1, 2015

(54) GENERIC EXPOSURE OF ENTERPRISE RESOURCE PLANNING DATA USING A CLOUD-BASED, ON-DEMAND SERVICE

(71) Applicant: SAP AG, Walldorf (DE)

(72) Inventor: Olaf Schmidt, Walldorf (DE)

(21) Appl. No.: 13/931,103

(22) Filed: Jun. 28, 2013

(51) Int. Cl. H04L 12/911

(52) U.S. Cl. CPC H04L 47/726; H04L 47/783
USPC 709/226

(57) ABSTRACT

The present disclosure describes methods, systems, and computer program products for providing generic exposure of enterprise resource planning (ERP) data using a cloud-based, on-demand service. One computer implemented method includes receiving a data request for backend data stored in a backend system apart from the cloud-based, gateway services environment, generating a request in the gateway services environment for a service to handle the received data request, transmitting the generated request to a service repository to retrieve an appropriate service definition based upon component data request parameters, instantiating an instance of a generic data provider based upon a returned service definition, retrieving a model of the returned service definition, the model describing a data structure of at least one data entity provided by the service defined by the service definition, and retrieving runtime data from the backend system using the retrieved model of the returned service definition.

### BACKGROUND

Service-oriented application and integration platforms, such as enterprise resource planning (ERP) systems, typically use a “gateway”-type system, such as a gateway server, to act as an interface between a client and a suite of ERP applications and/or other applications associated with a customer hardware/software landscape. The gateway server is normally integrated as an additional component as part of a customer's on-premises-based ERP environment to provide an interface for internal/external clients wishing to access the ERP system applications and/or associated data. The installed gateway server results in a greater total cost of ownership (TCO) for a customer due to, among other things, the need for additional hardware, software, security, and maintenance to provide the customer-supplied gateway services.

### SUMMARY

The present disclosure relates to computer-implemented methods, computer-readable media, and computer systems for providing generic exposure of enterprise resource planning (ERP) data using a cloud-based, on-demand service. One computer implemented method includes receiving a data request from a consumer in a cloud-based, gateway services environment, the data request for backend data stored in a backend system apart from the cloud-based, gateway services environment, generating a request for a service to handle the received data request, the request including component data request parameters, transmitting the generated request to a service repository to retrieve an appropriate service definition based upon the component data request parameters, instantiating an instance of a generic data provider based upon a returned service definition, retrieving a model of the returned service definition, the model describing a data structure of at least one data entity provided by the service defined by the service definition, and retrieving runtime data from the backend system using the retrieved model of the returned service definition.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprising, parsing the received data request into the component data request parameters.

A second aspect, combinable with any of the previous aspects, further comprising determining whether the returned service definition specifies a generic data provider.

A third aspect, combinable with any of the previous aspects, wherein retrieving a model further comprises: requesting destination information for the backend system and retrieving metadata from the backend system to create a metadata document.

A fourth aspect, combinable with any of the previous aspects, further comprising: retrieving language support texts from the backend system and rendering the metadata document.

A fifth aspect, combinable with any of the previous aspects, wherein retrieving runtime data further comprises: requesting destination information for the backend system and retrieving runtime data from the backend system.

A sixth aspect, combinable with any of the previous aspects, further comprising converting the runtime data into a consumer supported data format for transmission to the consumer.

The subject matter described in this specification can be implemented in particular implementations so as to realize one or more of the following advantages. First, customers are not required to install and/or maintain an additional component within their on-premises enterprise resource planning (ERP) landscape to provide gateway services for accessing ERP applications/data. This lowers a total cost of ownership for the customer and allows the customer to develop, build, test, host, and run an on-demand ERP application without the need to care about infrastructure or operations related to gateway services. Second, providing gateway services in a cloud-computing-based environment allows gateway services for on-demand ERP applications to be shared by many different customers. Depending on customer needs, security, etc., in some configurations, a particular customer can be isolated to a dedicated machine(s) (physical and/or virtual) in the cloud-computing-based gateway services. In a shared configuration, although the gateway services can be shared by different customers, data is isolated by customer ensuring customer data privacy and protection. Third, a particular customer can perform a configuration of services to expose that are particular to the customer (e.g., service name, service version, destination pointer to an ERP system, and the like). Customers are provided with full control/auditability of what is exposed to clients with the cloud-computing-based gateway services. Fourth, updates can be efficiently applied to the cloud-computing-based gateway services ensuring that customers have a more consistent and error-free user experience. Fifth, Data security is also enhanced because the cloud-computing-based gateway services are hosted on secured and controlled systems, and provide trusted connections for both clients and customers. Sixth, gateway service reliability is enhanced by the cloud-computing-based services as the cloud-based environment allows for automatic failover, automatic updates, and the like. Seventh, a cloud service provider can leverage an additional pricing model for services apart from a standard licensing of a software component. For example, a customer can be charged based on utilization of the service (e.g., an amount of data retrieved form ERP system, number of service calls, etc.) The amount of data can be determined by monitoring the traffic induced by a particular customer and billing the customer for the determined traffic. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for providing generic exposure of enterprise resource planning (ERP) data using a cloud-based, on-demand service according to an implementation.

FIG. 2 is a block diagram illustrating a high-level architecture of a gateway services cloud (GSC) and a customer landscape according to an implementation.

FIG. 3 is a block diagram illustrating lower-level architecture of a GSC according to an implementation.

FIGS. 4A-4B illustrate a sequence diagram of a method for providing generic exposure of enterprise resource planning (ERP) data using a cloud-based, on-demand service according to an implementation illustrated in FIG. 3.

Like reference numbers and designations in the various drawings indicate like elements.

### DETAILED DESCRIPTION

This disclosure generally describes computer-implemented methods, computer-program products, and systems for providing generic exposure of enterprise resource planning (ERP) data using a cloud-based, on-demand service. The following description is presented to enable any person skilled in the art to make and use the invention, and is provided in the context of one or more particular implementations. Various modifications to the disclosed implementations can be made, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

For the purposes of this disclosure, an enterprise resource planning (ERP) system integrates both internal and external organizational management information across the entire organization. ERP system applications assist the organization to manage financial/accounting, manufacturing, sales and service, customer relationship management, human resources, and other suitable functions and enable the flow of information between all business functions of the organization. The ERP is designed to aggregate, synthesize, and personalize information for organizational stakeholders who can use the presented information to make decisions for the organization.

A “gateway” acts as an interface between a client (or consumer) and a suite of ERP applications and/or other applications associated with a customer hardware/software landscape. The gateway allows easier provisioning and consumption of business logic and content of backend systems for mobile and web applications. The gateway also provides key support for the utilization of transactional business data stored in on-premise ERP systems by new and innovative applications running on various client devices leveraging evolving user interface (UI) technologies (e.g., smartphones, tablet computers, HTML5 (UI5) clients, and the like) using standard protocols like HTTP. The gateway exposes ERP data in open and standardized data formats (e.g., AtomPub, JSON, CSV, OData, and the like) for easy consumption by lightweight mobile and other applications.

The main drawback of an installed, on-premises gateway is that an additional system (hardware and/or software) must be installed in a customer landscape to provide the gateway services. The addition of an additional system leads to an increased total cost of ownership (TCO) for the customer due to, for example, additional hardware, software/licenses, system maintenance, and the like.

To overcome at least the described main drawback, this disclosure describes a generic, on-demand framework/sub-system to provide gateway functionality as an on-demand gateway-as-a-service (GWaaS) within a cloud-computing-based infrastructure. The GWaaS runs in a hosted system that can be connected to the on-premise ERP systems of customers and provides functionality to expose enterprise-ready services. Several customers (e.g., cloud tenants) can utilize the same gateway service in the cloud to access data stored in ERP systems running in the on-premise landscapes of the customers. The generic sub-system. The GWaaS exposes on-premises ERP data as a service in various data formats over the HTTP protocol. In other implementations, the ERP data can be provided over other protocols apart from HTTP. Provisioning of ERP data is possible with customer-specific configurations associated with the on-demand service.

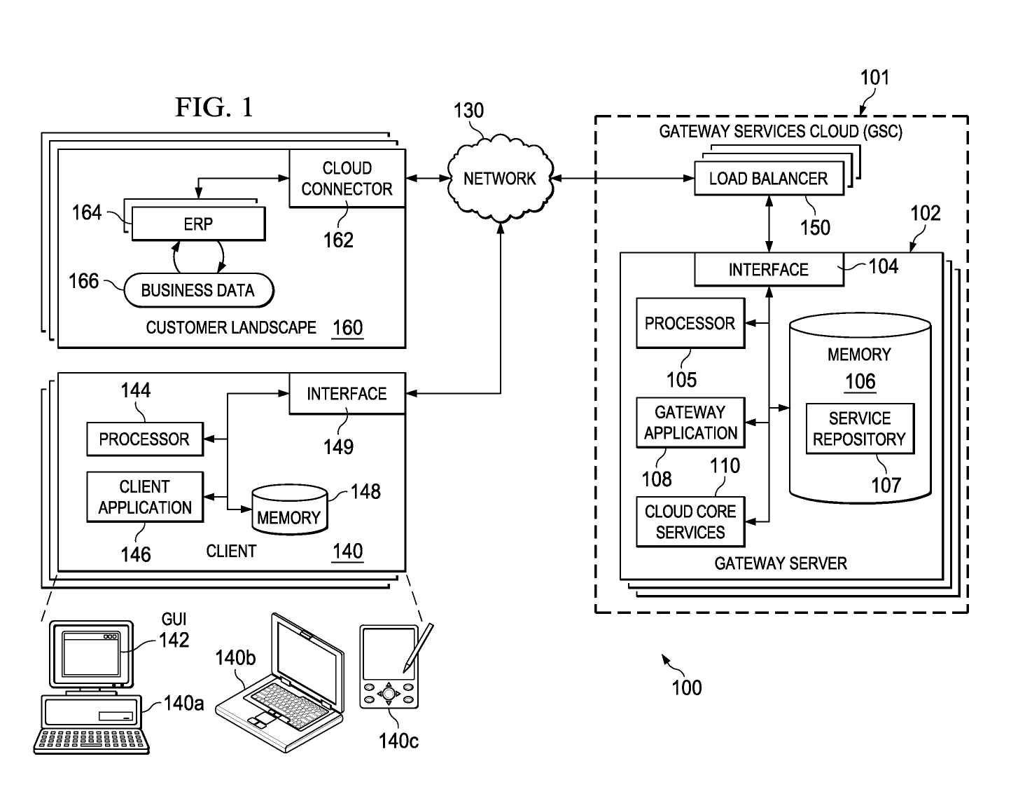

Depending on customer needs, security, etc., in some configurations, a particular customer can be isolated to a dedicated machine(s) (physical and/or virtual) in the cloud-computing-based gateway services. In a shared configuration, although the gateway services can be shared by different customers, data is isolated by customer ensuring customer data privacy and protection. The isolated machine(s) would still execute appropriate components described below with respect to FIGS. 1-4. In the isolated implementation, the request can be used to specify that the request it to be routed to the private system. For example, a URL parameter can be updated to specify the routing, such as “hosting.GWaaS” (for shared use of the GWaaS) or “ABCINC.GWaas” (for a private implementation of the GWaaS for company ABC, Inc.). The typical use case is to share the GWaaS among multiple users.

A particular customer can perform a configuration of services to expose that are particular to the customer (e.g., service name, service version, destination pointer to an ERP system, and the like). Customers are provided with full control/auditability of what is exposed to clients with the cloud-computing-based gateway services.

Updates can be efficiently applied to the cloud-computing-based gateway services ensuring that customers have a more consistent and error-free user experience. Customers would typically be updated to the latest versions of services, but could choose to run one or more older versions of services if necessary.

Data security is also enhanced because the cloud-computing-based gateway services are hosted on secured and controlled systems, and provide trusted connections for both clients and customers. Sixth, gateway service reliability is enhanced by the cloud-computing-based services as the cloud-based environment allows for automatic failover, automatic updates, and the like.

FIG. 1 is a block diagram illustrating an example distributed computing system (EDCS) 100 for providing generic exposure of ERP data using a cloud-based, on-demand service according to an implementation. The illustrated EDCS 100 includes or is communicably coupled with a gateway services cloud (GSC) 101 cloud-computing environment, one or more clients 140, and one or more customer landscapes 160 that communicate across a network 130. The GSC 101 includes one or more gateway servers (GS) 102 and one or more load balancers 150. In other implementations, other appropriate computing components can be coupled to the EDCS 100.

At a high level, the GSC 101 provides a client 140 with on-demand gateway service functionality that exposes ERP data from one or more customer landscapes 160 over the HTTP protocol. Requests received from a client 140 and/or responses from a customer landscape 160 are communicated across network 130. The load balancer 150 can be any hardware and/or software that provides functionality to distribute network workloads, for example GWaaS requests, from clients 140 (including cloud tenants) for ERP data from the one or more customer landscapes 160. The load balancer 150 optimizes GSC 101 resource use, maximizes throughput, minimizes response time, and avoids network request/response overloads. Received requests from clients 140 or other suitable components of the EDCS 100 are forwarded to a GS 102 for processing and to provide GWaaS functionality. For example, a particular load balancer 150 can analyze a received client request and forward the request to a determined GS 102 with “free” resources to maximize processing speed. In another example, the load balancer 150 can forward a request from a particular client 140 to a particular dedicated GS 102 set aside for security or other reasons. In some implementations, the foregoing and/or following described GWaaS functionality associated with a GS 102 can be wholly or partially implemented by a particular load balancer 150. For example, in a failover situation, a load balancer 150 could temporarily also assume the role of a GS 102. Although illustrated as an integral component of the GSC 101, in other implementations, the load balancer can be external to the GSC 101. In some implementations, the load balancer 150 functionality can be integrated into one or more GS 102. For example, a particular GS 102 could serve as a load balancer 150 as well as providing limited GS 102 functionality.

The GS 102 is an electronic computing device within the GSC 101 that is operable to receive, transmit, process, store, or manage data and information and provides GWaaS functionality. According to some implementations, the GS 102 may be, include, and/or be communicably coupled with an e-mail server, a web server, a caching server, a streaming data server, and/or other server.

In general, the GS 102 is a server, physical and/or virtual, that stores and/or executes one or more gateway applications 108 and/or cloud core services 110 responsive to requests/responses received from the load balancer 150, sent by another GS 102 (e.g., from a gateway application 108 and/or cloud core services 110), and/or other components (whether illustrated or not) within and communicably coupled to the illustrated EDCS 100. In some implementations, GS 102 can be accessed directly (e.g., apart from the load balancer 150 or with the load balancer 150 acting in a pass-through mode) using the network 130 to perform programmed tasks or operations of a particular gateway application 108 and/or associated components. Requests/responses may also be sent to the GS 102 from internal users, external or third-parties, other automated applications, as well as any other appropriate entities, individuals, systems, or computers (whether illustrated or not) either through or independent of the load balancer 150.

In some implementations, any and/or all components of the GS 102, both hardware and/or software, may interface with each other and/or the interface using an application programming interface (API) and/or a service layer (neither illustrated). The API may include specifications for routines, data structures, and object classes. The API may be either computer-language independent or dependent and refer to a complete interface, a single function, or even a set of APIs. The service layer provides software services to the GS 102 and/or other components of the EDCS 100. The functionality of the GS 102 may be accessible for all service consumers using this service layer. Software services, such as those provided by the service layer, provide reusable, defined business functionalities through a defined interface. For example, the interface may be software written in JAVA, C++, or other suitable language providing data in extensible markup language (XML) format or other suitable format. The API and/or service layer can be wholly or partial integral or stand-alone in relation to the GS 102 or components of the EDCS 100. Moreover, any or all parts of the API and/or the service layer may be implemented as child or sub-modules of another software module, application, and/or hardware module.

The GS 102 includes an interface 104. Although illustrated as a single interface 104 in FIG. 1, two or more interfaces 104 may be used according to particular needs, desires, or particular implementations of the EDCS 100 and/or the GS 102. The interface 104 is typically used by the GS 102 for communicating with the load balancer 150. In other implementations, the interface 104 can be used to communicate with other systems in a distributed environment—including within the EDCS 100—connected to the network 130; for example, the client 140, the customer landscape 160, and/or other systems (whether illustrated or not) that may be communicably coupled to the network 130. Generally, the interface 104 comprises logic encoded in software and/or hardware in a suitable combination and operable to communicate with the load balancer 150, other GS 102s, and/or other components within and/or external to the EDCS 100 using one or more communication protocols compatible with network 130.

The GS 102 includes a processor 105. Although illustrated as a single processor 105 in FIG. 1, two or more processors may be used according to particular needs, desires, or particular implementations of the EDCS 100 and/or the GS 102. The processor 105 executes instructions and manipulates data to perform the operations of the GS 102 and/or functionality required to provide generic exposure of ERP data using a cloud-based, on-demand service.

The GS 102 also includes a memory 106 (collectively of various types) that holds data for the GS 102 and/or other components of the EDCS 100 (whether illustrated or not). Although illustrated as a single memory 106 in FIG. 1, two or more memories may be used according to particular needs, desires, or particular implementations of the EDCS 100. While memory 106 is illustrated as an integral component of the GS 102, in alternative implementations, memory 106 can be external to the GS 102 and/or the EDCS 100.

In some implementations, the memory 106 can be wholly or partially an in-memory database. Although shown as integral to GS 102, at least portions of the memory 106 (e.g., an in memory database) is typically shared by multiple instances of GS 102. An in-memory database is a high-performance relational database management system (RDBMS) that primarily relies on volatile electronic memory, such as random access memory (RAM), as opposed to magnetic, optical, removable, or other suitable non-electronic memory, for storage, retrieval, and processing of data. The reliance on electronic memory allows, in some implementations, for near-real-time aggregation, replication, synchronization, and processing of data. In some implementations, a persistency layer ensures that a copy of the in-memory database is maintained on non-volatile magnetic, optical, removable, or other suitable non-electronic memory in the event of a power or other system failure in order to allow recovery of the in-memory database. In some implementations, the in-memory database can be replicated to one or more conventional databases (not illustrated) for backup purposes. In some implementations, data from the conventional database can be replicated to and used from the in-memory database.

In some implementations, the memory 106 includes an instance of a persistent service repository 107. The service repository 107 is shared between the one or more GS 102 instances within the GSC 101. The service repository 107 is a repository of service definitions accessed by the gateway application 108, typically by a specified service name and version. The service repository 107 is tenant aware in that requested services have a provided tenant attribute received in an on-demand gateway request. For example, the service repository 107 specifies which tenants have access to particular service definitions. The service repository also specifies the name of a data provider (e.g., a generic or custom data provider) to instantiate to serve the received request (see below for additional detail).

The gateway application 108 is an application that provides on-demand, GWaaS functionality for clients 140 seeking to access a customer's ERP applications and/or data associated with a customer landscape 160 from a client 140. Typically gateway applications 108 executing on different GS 102s are not aware of each other and do not communicate. They only share the same database/repository (e.g., the same service repository 107 illustrated as part of memory 106). In some implementations, gateway applications 108 can communication for any suitable purpose, for example administrative, to enhance processing speed, to provide additional security, failover purposes, etc.

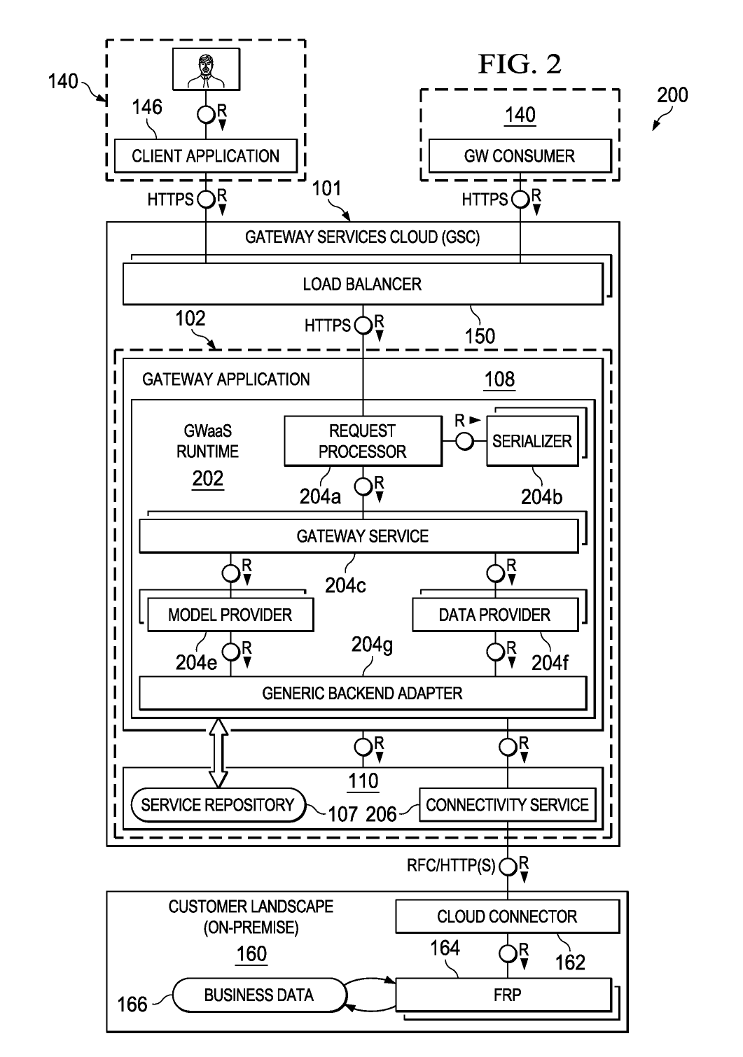

With respect to the gateway application 108, a defined tenant-specific service is related to one or more ERP systems located in the customer landscape 160. In other words, a service defined in the service repository 107 is mapped to a service running in one or more ERP backend systems. The information regarding the corresponding ERP systems is also stored in the service repository. Customers can also define aliases for the backend systems and the corresponding backend services using a destination service (described below). For example, the destination service can map an HTTP address to a symbolic name). During runtime, the GWaaS core (described below) looks up the requested service definition in the service repository 107 and uses the stored alias(es) to dispatch service requests to the corresponding ERP systems at the customer landscape 160. Additional detail is provided with descriptions of one or more gateway application 108 subcomponents in relation to the descriptions of FIGS. 2-4.

The cloud core services 110 provide core service functionality for the GS 102. For example, the cloud core services 110 can provide functionality to look-up service repository 107 definitions, provide destination information, and/or provide secure tunneling of on-demand to on-premises requests. The cloud core services 110 can also provide identity management, monitoring, logging and metering functionality. Additional detail for one or more illustrated cloud core services 110 is described below in relation to the description of FIGS. 2-4.

The client 140 (illustrated with examples 140a-140c) may be any computing device operable to connect to or communicate with at least the GSC 101 and/or the customer landscape 160 using the network 130. In some implementations, the client 140 can communicate directly with the customer landscape 160 or indirectly through the GSC 101 (and associated components) and/or another component of the EDCS 100. In general, the client 140 comprises an electronic computing device operable to receive, transmit, process, and store any appropriate data associated with the EDCS 100. Typically the client 140 will process and/or respond (both automatically and/or by manual user interaction) to requests and/or responses generated by the GSC 101 and/or the customer landscape 160. For example the client 140 can receive ERP data from the GSC 101 responsive to an ERP data request made to the GSC 101. The client 140 typically includes a client application 146, processor 144, a memory 148, and/or an interface 149.

The client application 146 is any type of application that allows the client 140 to navigate to/from, request, view, edit, delete, and or manipulate content on the client 140, for example ERP 164 data/business data 166 associated with a customer landscape 160. In some implementations, the client application can be an HTML 5-, IOS-, or ANDROID-based application. In some implementations, the client application 146 can be and/or include a web browser.

In some implementations, the client-application 146 can use parameters, metadata, and other information received at launch to access a particular set of data from the GSC 101, customer landscape 160, other client 140, and/or other component of the EDCS 100. Once a particular client application 146 is launched, a user may interactively process a task, event, or other information associated with the GSC 101, customer landscape 160, other client 140, and/or other components of the EDCS 100.

Although illustrated as a single client application 146 within the client 140, the client application 146 may be implemented as multiple client applications 146 in the client 140. In some implementations, the client application 146 may act as a GUI interface for another client application 146, the GSC 101, customer landscape 160, and/or other components of the EDCS 100.

The interface 149 is used by the client 140 for communicating with other computing systems within the EDCS 100, using network 130. For example, the client 140 can use the interface 149 to communicate with the GSC 101 (or associated components—including the customer landscape 160) as well as other clients 140 and/or systems (not illustrated) that can be communicably coupled to the network 130. The interface 149 may be consistent with the above-described interface 104 of the GS 102 or other interfaces (whether or not illustrated) within the EDCS 100, including the cloud connector 162. The processor 144 may be consistent with the above-described processor 105 of the GS 102 or other processors (whether or not illustrated) within the EDCS 100. Specifically, the processor 144 executes instructions and manipulates data to perform the operations of the client 140, including the functionality required to send requests to the GSC 101 and to receive and process responses from the GSC 101. The memory 148 typically stores objects and/or data associated with the purposes of the client 140 but may also be consistent with the above-described memory 106 of the GS 102 or other memories (whether or not illustrated) within the EDCS 100, and can be used to store data similar to that stored in the other memories of the EDCS 100 for purposes such as backup, caching, and the like.

Further, the illustrated client 140 includes a GUI 142. The GUI 142 interfaces with at least a portion of the EDCS 100 for any suitable purpose, including generating a visual representation of a web browser and/or other GUI interface. The GUI 142 may be used to view and navigate among various web pages located both internally and externally to the GS 102/database server 150, view data associated with the GS 102, database server 150, and/or the client 140, or for any other suitable purpose. In particular, the GUI 142 may be used in conjunction with content from GS 102, database server 150, and/or the client 140 to provide application integration functionality directly on a relational database.

There may be any number of clients 140 associated with, or external to, the EDCS 100; the number of client suitable to the purposes of the EDCS 100 and/or components of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (some example configurations illustrated as 140a-140c) is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the GSC 101 (or associated components—including the customer landscape 160) or the client 140 itself, including digital data, visual and/or audio information, or a GUI 142, as shown with respect to the client 140.

In some implementations, any and/or all components of the client 140, both hardware and/or software, may interface with each other and/or the interface using an application programming interface (API) and/or a service layer (neither illustrated). The API may include specifications for routines, data structures, and object classes. The API may be either computer-language independent or dependent and refer to a complete interface, a single function, or even a set of APIs. The service layer provides software services to the EDCS 100. The functionality of the client 140 may be accessible for all service consumers using this service layer. Software services, such as those provided by the service layer, provide reusable, defined business functionalities through a defined interface. For example, the interface may be software written in JAVA, C++, or other suitable language providing data in extensible markup language (XML) format or other suitable format. The API and/or service layer can be wholly or partial integral or stand alone in relation to the client 140 or components of the EDCS 100. Moreover, any or all parts of the API and/or the service layer may be implemented as child or sub-modules of another software module, enterprise application, or hardware module.

The customer landscape 160 represents an on-premises customer ERP system (as described above). The customer landscape 160 typically does not have a customer-landscape-installed gateway acting as an interface between a client and the customer landscape 160. In some implementations, the customer landscape 160 includes a cloud connector 162, an ERP 164, and/or ERP-associated business data 166. The cloud connector 162 provides secure tunneling of on-demand requests received from the GSC 101 to on-premise ERP 164 requests. The cloud connector 160 also provides a mapping of users from the GSC 101 to the customer landscape 160. Typically, a GSC 101 user is authenticated with a cloud user account. The ERP systems in the customer landscape 160 have their own user-management mechanisms and a user existing in the cloud does not necessarily exist in the backend system. Therefore, mechanisms are needed to map on-demand users to existing on-premise users taking into account the granted privileges in the ERP backend systems. The connectivity service 110 and cloud connector 162 provide this functionality.

FIG. 2 is a block diagram illustrating a high-level architecture 200 of a gateway services cloud (GSC) 101 and a customer landscape 160 according to an implementation. In FIG. 2, a request is generated by a client application 146 or a general GW consumer as part of a client 140. The request is typically a secure HTTPS request (e.g., containing a URL), but in other implementations, the request can be of any format. The request is received by a load balancer 150 which determines which GS 102 to transfer the received request to for handling. In some implementations, the load balancer 150 (and other components) can be tenant aware. For example, requests received that are associated with a particular client can be forwarded to a particular GS 102 for processing. Otherwise, the requests can be generally handled by any particular GS 102.

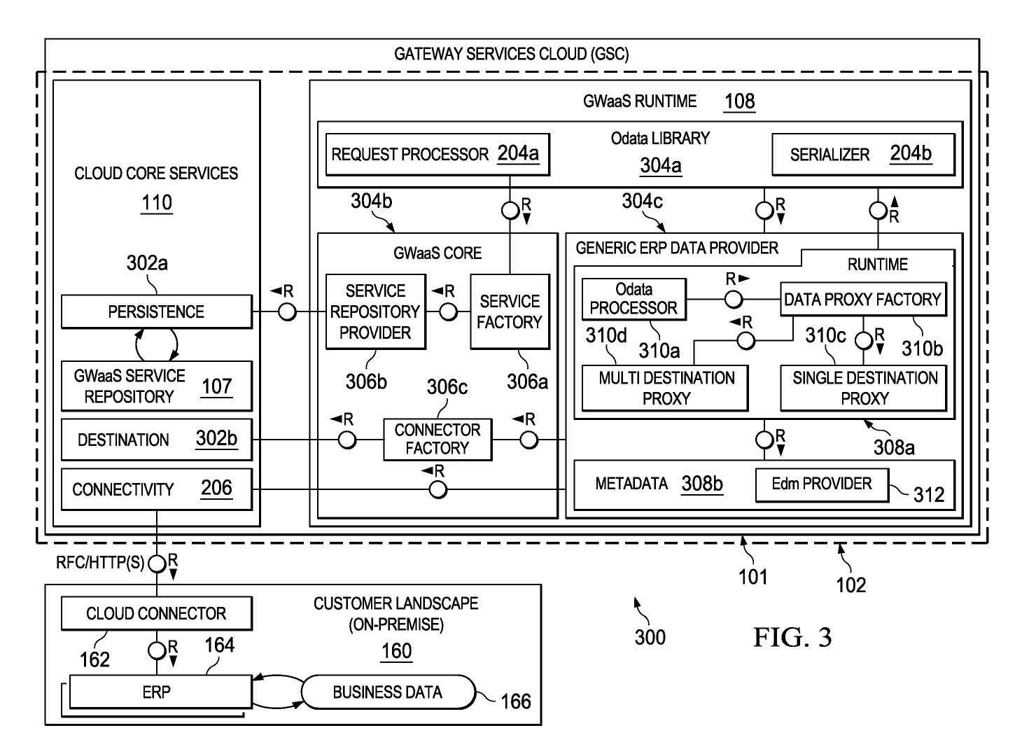

At a high level, the GWaaS runtime 108 receives the request forwarded by the load balancer 150. The request processor 204 is a component of an OData library (refer to FIG. 3) and analyzes and parses the received URL for component URL parameters such as service name, service version, destination, and other values. The parsed information is then forwarded to the gateway service 204c. Note that a customer can have multiple versions of the same service name (e.g., service “Flight” versions 1.0, 2.0, 2.5, 2.7, 3.1, etc.) available for access by a client. It would only take specifying a particular version of the service name in the request URL. Note that while multiple service versions may be available, there is typically only one version of the GWaaS runtime 202 for use by all clients 140.

The gateway service 204c accesses ERP data stored in on-premise systems installed in the customer landscape 160. The gateway service 204c utilizes the provided information from the service repository to identify the corresponding backend systems and backend services which are used during runtime (e.g., retrieval of metadata and runtime data). The gateway service 204c is one concrete instance of the Generic ERP Data Provider as illustrated in FIG. 3. Note that the gateway core (refer to FIG. 3) instantiates one data provider for every incoming request. In general gateway as a service provides APIs to implement many kinds of gateway services and the generic ERP data provisioning service is one particular service. In an example for implementing a custom social media provider, the GWaaS runtime 108 can instantiate a custom gateway service based on a social media data provider and the service would access the remote social media service to retrieve data and expose it as OData.

The gateway service 204c uses the above-described parsed information to look-up a service definition for the requested service (service name, version, etc.) in the service repository 107. As described above, the service repository 107 is tenant aware. With each request URL, a tenant is specified. For example, if a client 140 requested backend data from a company ABC customer landscape 160, only services associated with company ABC are accessible in the service repository 107 for the particular request. As part of the service definition in the service repository 107, an associated model provider 204e and a data provider 204f is specified. The model provider 204e (many possible types) provides a description of the data model of the requested service. For example, the model provider 204 can describe what kind of data is exposed in the context of the requested service (e.g., collections, entities, etc.). The data provider 204f (many possible types) is responsible for retrieving the requested data from the customer landscape 160. While in some implementations, customers can implement their own custom model provider 204e/data provider 204f that are accessible using API's, this disclosure focuses on implementing a generic ERP data provider (refer to FIG. 3) for use by customers requiring only basic configuration actions by the customers (service name, service version, mapping to destinations, and a mapping to a generic data provider). For example, in the customer configuration, each configured service could have row in a shared configuration database/persistency (e.g., the service repository 107) with data describing service name, service version, data destination, model provider name (generic or custom), and the like.

The backend adaptor 204g is a layer which hides protocol details and the services (model and data providers) utilize API's rather than dealing with the protocol details. In some implementations, communication between the on-demand and the on-premise world via the connectivity service is HTTP based. Other implementations can support additional protocols, for example remote function calls (RFC).

The GWaaS runtime 108 instantiates an instance of the specified model provider 204e and the data provider 204f (generic or custom) using a service factory subcomponent (see FIG. 3). The instantiated model provider 204e and data provider 204f handle request processing for the request. The requested data is retrieved across the connectivity service 206 (part of the cloud core services 110) from the customer landscape 160. The retrieved requested data is processed by the request processor 204 and the retrieved data converted/serialized by serializer 204b (also part of the OData library described in FIG. 3) into a format compatible with a requesting client application 146 and transmitted to the requestor.

The GWaaS runtime 108 also provides tenant isolation in that requests for service definitions are performed for particular tenants based upon tenant information received in a request URL. For example, if a request for backend data from company ABC, Inc.'s customer landscape 160 is received, the GWaaS runtime 108 will request a service definition from the service repository 107 that will be limited to services for company ABC, Inc.

FIG. 3 is a block diagram illustrating lower-level architecture 300 of a GSC 101 according to an implementation. FIG. 3 provides additional detail as to sub-components of the cloud cloud core services 110 and then GWaaS runtime 108. The cloud core services includes a persistence service 302a, the GWaaS repository 107, a destination service 302b, and the connectively service 206 (described in FIG. 2). The GWaaS runtime 108 is illustrated with an OData library 304a, an GWaaS core 304b, and a generic ERP data provider 304c.

The OData library 304a is a library for building OData producers. The OData library 304a supports the implementation of services which are compliant to the OData standard. The services support a defined set of URL parameters (e.g., a defined uniform resource identifier (URI) schema), the provisioning of the service document (e.g., a list of feeds or entity sets provided by the service), the metadata document (e.g., an entity data model of the service), and the exposure of the actual runtime data. In some implementations, OData producers are in JAVA. In other implementations, or other appropriate languages can be supported. The OData library 304a implements the OData standard and provides services such as request URL processing/parsing and serialization of results for return to a requestor. The OData library is part of the GWaaS runtime 108 (not originally illustrated in FIG. 2) and encapsulates the request processor 204b and serializer 204c illustrated as separate components in FIG. 2. Although illustrated as an OData library, the library can support other standards/protocols apart from OData.

The GWaaS core 304b provides functionality to access the service repository 107 and invokes the correct processors for incoming requests. The GWaaS core 304b (not illustrated in FIG. 2) provides functionality to look-up services in the service repository using a service repository provider 306b and to instantiate a corresponding OData processor and electronic data management (EDM) provider 312 with a service factory 306a based on a data provider class and model provider class maintained with a definition of a requested service in the service repository. A connector factory 306c allows the lookup of configured backend connections (destination) using the destination service 302b/connectivity service 206 in the cloud core services 110. The cloud has an API/service 302b to retrieve destination information based on a destination name (e.g., an alias such as “XYZ”). The generic ERP data provider 304c (or custom data provider) can call the connector factor 306c and request a connection class for destination alias. The destination API/service 302b retrieves an object of a destination handler (connectivity service 206) and returns it to the appropriate data provider (generic or custom) which is used to securely connect to the customer landscape 160.

The generic ERP data provider 304c is one instance of model provider 204e and data provider 204f as illustrated in FIG. 2 and supports the generic exposure of existing OData services in an on-premises backend system and includes both a runtime 308a and metadata 308b. The generic ERP data provider 304c is responsible for connecting to backend systems and communication with backend services to retrieve back-end data as well as building in-memory data structures for serialization of response data.

The runtime 308a includes an OData processor 310a, data proxy factory 310b, single destination proxy 310c, and a multi destination proxy 310d and maps to the illustrated data provider 204f in FIG. 2. The OData processor 310a implements an ODataSingleProcessor interface of the OData library. The OData Processor 310a is responsible for executing corresponding create, read, update, and delete (CRUD) operations for incoming request (e.g., single entity read, read feed, read metadata, read service document, create/update/delete entity, and the like). The data proxy factory 310b processes a matrix URL parameter if specified with a received request. The matrix parameter can specify if the request is for a single or multi destination. Based on the parameter, the data proxy factory 310b instantiates a single-destination proxy 310c or a multi-destination proxy 310d. In some implementations, if the matrix parameter is unavailable, the data proxy factory 310b instantiates a single-destination proxy 310c by default. The typical use case is for a single-destination proxy to be used to access a single backend system. The single-destination proxy 310c implements a dedicated interface used by the OData processor 310a to delegate an incoming request to an appropriate data proxy. The single-destination proxy 310c executes single-destination requests. The multi-destination proxy 310d implements a dedicated interface used by the OData processor 310a to delegate an incoming request(s) to an appropriate data proxy. The multi-destination proxy 310d executes multi-destination requests (e.g., parallel requests to more than one connected ERP system/customer landscape 160) and handles the merging of response data from the ERP systems/customer landscapes 160 (if necessary).

The metadata 308b includes an EDM provider 312. The EDM provider 312 is responsible for retrieving a meta-model of an exposed backend service. The metadata 308b/EDM provider 312 maps to one type of model provider 204e illustrated in FIG. 2. The metadata 308b describes the data model of a service, for example the OData collections/specifications that are exposed as part of the service. An example could be a “Flight” service with collections (flights, bookings, airports, etc.). The metadata 308b contains information about entity sets (flights, bookings, airports, etc.) and specifications for the returned data (field lengths, data types, etc.). Using the metadata 308b, the returned runtime data can be used, for example, to map the runtime data to UI interface fields.

In some implementations, the generic ERP data provider 304c leverages/reuses legacy services, APIs, protocols, frameworks, etc. on the customer landscape 160. The generic ERP data provider 304c abstracts the user from needing knowledge of specific legacy requirements for the customer landscape 160.

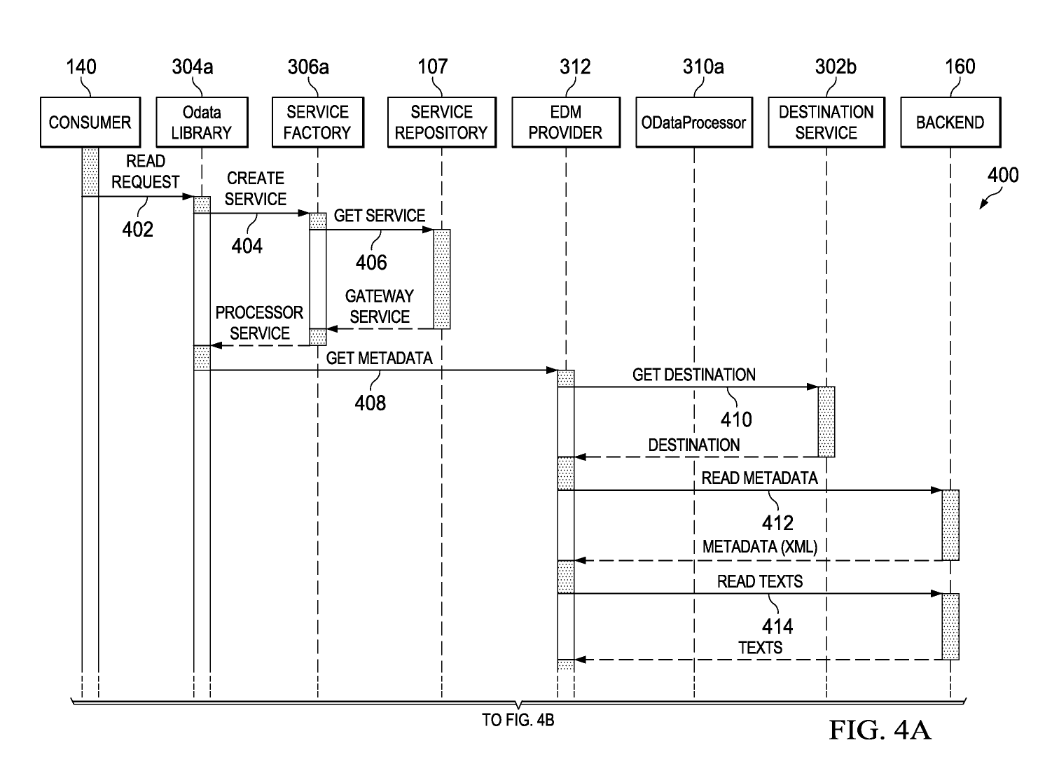

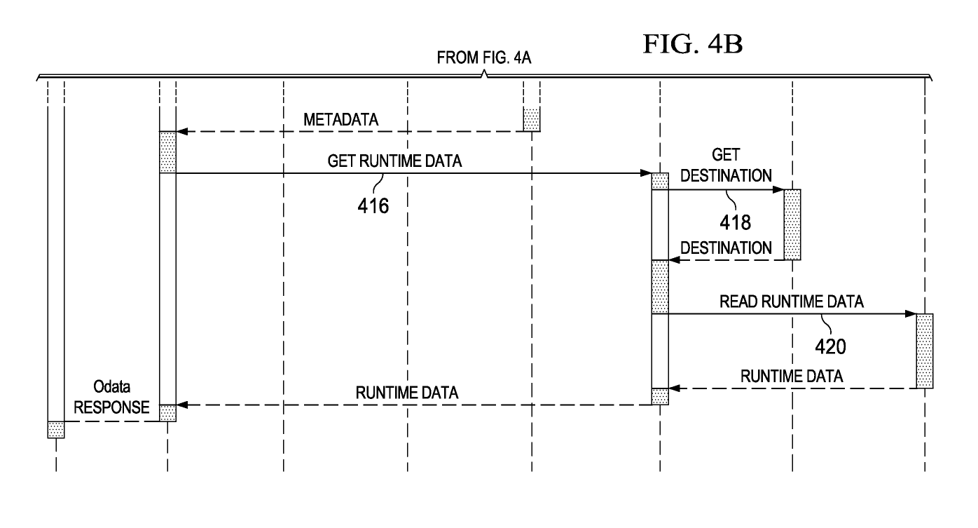

FIGS. 4A-4B illustrate a sequence diagram of a method 400 for providing generic exposure of enterprise resource planning (ERP) data using a cloud-based, on-demand service according to an implementation illustrated in FIG. 3. The sequence diagram represents an example of a non-modifying read request for ERP data from a mobile application using the generic ERP data provider 304c (described above in FIG. 3). For clarity of presentation, the description that follows generally describes method 400 in the context of FIGS. 1-3. However, it will be understood that method 400 may be performed, for example, by any other suitable system, environment, software, and hardware, or a combination of systems, environments, software, and hardware as appropriate. In some implementations, various steps of method 400 can be run in parallel, in combination, in loops, or in any order.

The described framework implementing the functionally to execute the illustrated sequence diagram implements a REST architecture where services are resources and CRUD operations are supported on all exposed resources. Modifying resources for ERP data (e.g., create, read, update, and delete) are supported analogue to a read-request.

At 402, a request (e.g., a uniform resource locator (URL)) is received from a consumer 140 (e.g., client 140) for data from a backend 160 (e.g., a customer landscape 160) is received by an OData library 304a from a consumer (e.g., a client 140). In some implementations, the request can be received through a load balancer (e.g., 150 in FIG. 2). The request processor 204a analyzes and parses the received URL into component URL parameters such as service name, service version, destination, and other values. From 402, method 400 proceeds to 404.

At 404, a request to create a service to handle the received request is made to a service factory 306a (part of the GWaaS core 304b in FIG. 3). The parsed URL information (particularly the service name and service version) is passed to the service factory 306a. From 404, method 400 proceeds to 406.

At 406, service factory 306a requests a service definition from the service repository 107 by service name/service version. In typical implementations, the request is passed through a service repository provider 306b which makes the actual request to the persistent service repository 107 for the appropriate service definition. The service repository 107 returns the service definition, including the name of the provider to instantiate to serve the particular request. For example, if the service definition specified the generic ERP data provider 304c as handling the request, the service factory 306a can instantiate an instance of the generic ERP data provider 304c. The instantiated instance of the generic ERP data provider 304c (“data provider”) is then handed back to the OData library 304a. If, however, the service definition specified a non-generic data provider, the service repository provider 306b would pass the information to the service factory 306a to instantiate the non-generic data provide and the instantiated instance is handed to the OData library 304a. From 406, method 400 proceeds to 408.

At 408, the OData library 304a uses the instantiated data provider to retrieve a model of the requested service using the EDM provider 312. The model describes the data structure of at least one entity provided by the service. The data structure of the model describes to which data type a particular piece of information exposed by the OData (gateway) service is mapped. For example, for a flight service which provides a flight information feed, the service exposes a collection of flights where each entry in the collection has the same structure and is based on the same data model (e.g., all entries would provide information about the carrier id, the departure time, the arrival time, the destination, etc.). In this example, the carrier id is mapped to a string data object, the arrival and departure time to a date/time data object and the destination to a string data object or a geolocation data object. The exact mapping is described in the metadata document of the OData service. Therefore, a client of the OData service first retrieves the metadata document from the service in order to map the runtime data according to the mapping information provided by the metadata document. From 408, method 400 proceeds to 410.

At 410, the EDM provider 312 requests destination information for the backend 160. The EDM provider 312 requests the destination information using the connector factory 306c. The connector factory 306c allows the lookup of configured backend connections (destination) using the destination service 302b/connectivity service 206 in the cloud core services 110. The destination service can retrieve destination information for the backend 160 based on a destination name (e.g., an alias such as “XYZ”). The EDM provider 312 (or custom model provider) can call the connector factory 306c and request a connection class for the supplied destination alias. The destination service 302b retrieves an object of a destination handler (connectivity service 206) and returns it to the appropriate model provider (generic or custom) which is used to securely connect to the customer landscape/backend 160. From 410, method 400 proceeds to 412.

At 412, the EDM provider 312 requests metadata from the backend 160. The generic ERP service provider running in the cloud retrieves the metadata information from the ERP backend system (in an proprietary XML format) using the retrieved destination data. The metadata information is used to create an OData metadata document (entity data model) to send to the client. From 412, method 400 proceeds to 414.

At 414, the EDM provider 312 reads texts from the backend 160. The texts information is related to the metadata. The backend systems can provide sophisticated translation support. Therefore, texts are maintained supporting various languages. In the example above, the GWaaS runtime 108 can detect the accepted languages of the client (e.g., based on the HTTP accepted language header information). If the accepted language header information indicates that the client accepts, for example German, the description texts of the data elements in the entity data model are retrieved in German from the backend system. For the above flight example, a German carrier ID could be “Flugesellschaft”, the departure time could be “Abflugzeit”, arrival time could be “Ankunftzeit,” etc. This information can be integrated into the metadata document and the client can utilize this information for internationalization. The metadata is then passed back to the OData Library 304a. The OData library 304a renders the metadata document in a format defined in the OData specification. The GWaaS runtime 108 utilizes the OData library 304a API to pass the information regarding the data type mapping (the entity data types). The OData library 304a renders the metadata document based on the provided information. In some implementations, there is exactly one metadata document for each service. In some implementations, all information retrieved from ERP systems for a particular service are related to the same entity data model. From 414, method 400 proceeds to 416.

At 416, the OData library 304a uses the retrieved service model to request runtime data from the OData processor 310a. From 416, method 400 proceeds to 418.

At 418, the OData processor 310a requests destination information for the backend 160 using the connector factory 306c (as described above). From 418, method 418 proceeds to 420.

At 420, the OData processor 310a reads runtime data from the backend 160 using the connectivity service 206. The retrieved runtime data is returned from the OData processor 310a to the OData library 304a. The serializer 204b of the OData library 304a, converts the retrieved runtime data into an OData response and returns the OData response to the consumer 140. In other implementations, the serializer 204b can convert the runtime data into any appropriate format for consumer 140 consumption. After 420, method 400 stops.

Although the concepts herein have been described primarily with an on-premises ERP customer landscape (refer to FIGS. 2 & 3), those of skill in the art will appreciate that the customer landscape can be other than an ERP system. Those of skill in the art will appreciate that the customer landscape can also be cloud-computing-based. Various customer-centric, cloud-computing-based technologies can be substituted and appropriate changes made to the described technology without deviating from the spirit and scope of the disclosure. The present disclosure is not intended to be limited to the described and/or illustrated implementations, but is to be accorded the widest scope consistent with the principles and features disclosed herein.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDFLOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an GS, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a data request from a consumer in a cloud-based, gateway services environment, the data request for backend data stored in a backend system apart from the cloud-based, gateway services environment;
generating a request for a service to handle the received data request, the request including component data request parameters;
transmitting the generated request to a service repository to retrieve an appropriate service definition based upon the component data request parameters;
instantiating, using a computer, an instance of a generic data provider based upon a returned service definition;
retrieving a model of the returned service definition, the model describing a data structure of at least one data entity provided by the service defined by the service definition; and
retrieving runtime data from the backend system using the retrieved model of the returned service definition.

2. The method of claim 1, further comprising, parsing the received data request into the component data request parameters.

3. The method of claim 1, further comprising determining whether the returned service definition specifies a generic data provider.

4. The method of claim 1, wherein retrieving a model further comprises:
requesting destination information for the backend system; and
retrieving metadata from the backend system to create a metadata document.

5. The method of claim 4, further comprising:
retrieving language support texts from the backend system; and
rendering the metadata document.

6. The method of claim 1, wherein retrieving runtime data further comprises:
requesting destination information for the backend system; and
retrieving runtime data from the backend system.

7. The method of claim 1, further comprising converting the runtime data into a consumer supported data format for transmission to the consumer.

8. A non-transitory, computer-readable medium storing computer-readable instructions executable by a computer to:
receive a data request from a consumer in a cloud-based, gateway services environment, the data request for backend data stored in a backend system apart from the cloud-based, gateway services environment;
generate a request for a service to handle the received data request, the request including component data request parameters;
transmit the generated request to a service repository to retrieve an appropriate service definition based upon the component data request parameters;
instantiate an instance of a generic data provider based upon a returned service definition;
retrieve a model of the returned service definition, the model describing a data structure of at least one data entity provided by the service defined by the service definition; and
retrieve runtime data from the backend system using the retrieved model of the returned service definition.

9. The medium of claim 8, further comprising instructions to parse the received data request into the component data request parameters.

10. The medium of claim 8, further comprising instructions to determine whether the returned service definition specifies a generic data provider.

11. The medium of claim 8, wherein retrieving a model further comprises instructions to:
request destination information for the backend system; and
retrieve metadata from the backend system to create a metadata document.

12. The medium of claim 11, further comprising instructions to:
retrieve language support texts from the backend system; and
render the metadata document.

13. The medium of claim 8, wherein retrieving runtime data further comprises instructions to:
request destination information for the backend system; and
retrieve runtime data from the backend system.

14. The medium of claim 8, further comprising instructions to convert the runtime data into a consumer supported data format for transmission to the consumer.

15. A computer-implemented system comprising:
a memory configured to hold a service repository; and
a processor interoperably coupled with the memory and configured to perform operations to:
receive a data request from a consumer in a cloud-based, gateway services environment, the data request for backend data stored in a backend system apart from the cloud-based, gateway services environment;
generate a request for a service to handle the received data request, the request including component data request parameters;
transmit the generated request to a service repository to retrieve an appropriate service definition based upon the component data request parameters;
instantiate an instance of a generic data provider based upon a returned service definition;
retrieve a model of the returned service definition, the model describing a data structure of at least one data entity provided by the service defined by the service definition; and
retrieve runtime data from the backend system using the retrieved model of the returned service definition.

16. The system of claim 15, further comprising instructions to parse the received data request into the component data request parameters.

17. The system of claim 15, further configured to determine whether the returned service definition specifies a generic data provider.

18. The system of claim 15, wherein retrieving a model is further configured to:
request destination information for the backend system; and
retrieve metadata from the backend system to create a metadata document.

19. The system of claim 18, further configured to:
retrieve language support texts from the backend system; and
render the metadata document.

20. The system of claim 15, wherein retrieving runtime data is further configured to:
request destination information for the backend system; and
retrieve runtime data from the backend system.

21. The system of claim 15, further configured to convert the runtime data into a consumer supported data format for transmission to the consumer.
